(19) United States
(12) Patent Application Publication
(10) Pub. No.: US 2009/0207618 A1
(43) Pub. Date: Aug. 20, 2009

(54) LIGHT SOURCE APPARATUS, IMAGE DISPLAY APPARATUS, AND MONITOR APPARATUS

(75) Inventor: Akira EGAWA, Shiojiri-shi (JP)

Correspondence Address: Workman Nydegger;1000 Eagle Gate Tower, 60 East South Temple, Salt Lake City, UT, 84111, US

(73) Assignee: SEIKO EPSON CORPORATION, Tokyo (JP)

(21) Appl. No.: 12/369,865

(22) Filed: Feb. 12, 2009

(30) Foreign Application Priority Data
Feb. 15, 2008 (JP) 2008-034112

(51) Int. Cl. F21V 13/00

(52) U.S. Cl. 362/296.01

(57) ABSTRACT

A light source apparatus includes: a light emitting element including a plurality of light emitting modules; a resonator; a transmitting-reflecting module which, being provided in an optical path between the light emitting element and the resonator, reflects one portion of light traveling from the resonator, and transmits another one portion; a current supply module; and at least one wiring module which connects the current supply module and the light emitting element, wherein a normal of a surface of the transmitting-reflecting module on which the light from the resonator falls incident is tilted in a specific direction relative to a main beam of a light flux which travels between the transmitting-reflecting module and the resonator, and at least one of the wiring modules is provided on a side of the light emitting modules opposite to a side of the specific direction.

### BACKGROUND

1. Technical Field

The present invention relates to a light source apparatus, an image display apparatus, and a monitor apparatus, and in particular, to a technology of a light source apparatus which has a wavelength conversion element and an external resonator.

2. Related Art

In recent years, as a light source apparatus of a projector or the like, a technology using a laser light source which supplies a laser light has been proposed. In comparison with a UHP lamp, which has heretofore been used as a projector light source apparatus, the laser light source has advantages such as a high color reproducibility and instant lighting being possible, and having a long lifespan. As the laser light source, as well as one which directly supplies a fundamental wave light emitted from a light emitting element, one is known which converts a wavelength of the fundamental wave light and supplies it. As a wavelength conversion element which converts the wavelength of the fundamental wave light, for example, a second harmonic generation (SHG) element is used. By using the wavelength conversion element, it is possible, using a widely available general-purpose light emitting element, to supply a laser light with a desired wavelength. Also, it is also possible to adopt a configuration which enables a supply of a laser light with a sufficient light quantity. It is known that a wavelength conversion efficiency in the SHG element is generally around 30 to 40%. In a case of adopting a configuration wherein the fundamental wave light is simply caused to fall incident on the SHG element, a strength of a harmonic light emitted due to the wavelength conversion in the SHG element is extremely low with respect to an output of the fundamental wave light. A technology for supplying a laser light wavelength converted with a high efficiency is proposed in, for example, JP-A-59-128525. With the technology proposed in JP-A-59-128525, the fundamental wave light is separated from light which has passed through the SHG element, and caused to fall incident again on the SHG element.

In the case of the configuration proposed in JP-A-59-128525, in order to synthesize light whose wavelength has been converted by the SHG element, and light whose wavelength has been converted by causing a fundamental wave light which has passed once through the SHG element to fall incident on the SHG element again, a complex and large-scale configuration is necessary. Also, as the light is caused to fall incident on a large number of optical elements, it also happens that a loss of light increases. In this way, according to the heretofore known technology, a problem occurs in that it is difficult to enable an efficient emission of light with a simple and compact configuration.

### SUMMARY

An advantage of some aspects of the invention is to provide a light source apparatus wherein a highly efficient emission of light is possible with a simple and compact configuration, and an image display apparatus and monitor apparatus which use the light source apparatus.

A light source apparatus according to an aspect of the invention includes a light emitting element including a plurality of light emitting modules which emit light, a resonator which resonates the light emitted from the light emitting modules, a transmitting-reflecting module which, being provided in an optical path between the light emitting element and the resonator, reflects one portion of light traveling from the resonator toward the light emitting element, and transmits another one portion, a current supply module which supplies a current to the light emitting modules, and at least one wiring module which connects the current supply module and the light emitting element. A normal of a surface of the transmitting-reflecting module on which the light from the resonator falls incident is tilted in a specific direction relative to a main beam of a light flux which travels between the transmitting-reflecting module and the resonator, and at least one of the wiring modules is provided on a side of the light emitting modules opposite to a side of the specific direction.

The light source apparatus is taken to be of a configuration such that a wavelength conversion element is disposed in the optical path between the transmitting-reflecting module and the resonator. Light whose wavelength has been converted by the wavelength conversion element, after passing through the resonator or being reflected by the transmitting-reflecting module, is emitted from the light source apparatus. Light whose wavelength has not been converted by the wavelength conversion element resonates between the light emitting modules and the resonator. With the light source apparatus, adopting a simple and compact configuration including a small number of optical elements, it is possible to reduce a loss of light. Furthermore, with the light source apparatus, by providing the wiring module on the side of the light emitting modules opposite to the side of the specific direction, it is possible to adopt a configuration such that the transmitting-reflecting module is disposed in a position as near as possible to the light emitting element, while preventing interference between the wiring module and the transmitting-reflecting module. By this means, it is possible to obtain a light source apparatus which enables a highly efficient emission of light with a simple and compact configuration.

Furthermore, a light source apparatus according to another aspect of the invention includes a light emitting element including a plurality of light emitting modules which emit light, a resonator which resonates the light emitted from the light emitting modules, a transmitting-reflecting module which, being provided in an optical path between the light emitting element and the resonator, reflects one portion of light traveling from the resonator toward the light emitting element, and transmits another one portion, a current supply module which supplies a current to the light emitting modules, and at least one wiring module which connects the current supply module and the light emitting element. A normal of a surface of the transmitting-reflecting module which reflects one portion of the light from the resonator is tilted in a specific direction relative to a main beam of a light flux which travels between the transmitting-reflecting module and the resonator, and at least one of the wiring modules is provided on a side of the light emitting modules opposite to a side of the specific direction.

According to this configuration, with the light source apparatus, by providing the wiring module on the side of the light emitting modules opposite to the side of the specific direction, it is possible to adopt a configuration such that the transmitting-reflecting module is disposed in a position as near as possible to the light emitting element, while preventing interference between the wiring module and the transmitting-reflecting module. By this means, it is possible to obtain a light source apparatus which enables a highly efficient emission of light with a simple and compact configuration.

Also, it is preferable that the light source apparatus includes a base on which the light emitting element is disposed, and a supporting module which supports at least the resonator on the base, wherein at least one of the wiring modules is provided on a side of the light emitting modules on which the supporting module is provided. By this means, it is possible to adopt a configuration such that the wiring module is provided on a side opposite to a side of a direction in which a normal of a surface of the transmitting-reflecting module on which the light from the resonator falls incident is tilted.

Also, it is preferable that the base and the supporting member configure a void, in a vicinity of the wiring module, penetrating from the light emitting element side to a side opposite to the light emitting element. By this means, by securing a space in which to dispose the wiring module, it is possible to prevent interference between the wiring module and the supporting module.

Also, it is preferable that the base and the supporting member configure a recessed portion, in the vicinity of the wiring module, which causes a depression in a surface on which the resonator is provided. By this means, by securing a space in which to dispose the wiring module, it is possible to prevent interference between the wiring module and the supporting module.

Also, it is preferable that the light source apparatus includes a wavelength conversion element which, by converting a wavelength of light with a first wavelength emitted from the light emitting modules, emits light with a second wavelength, which is a wavelength differing from the first wavelength, wherein the transmitting-reflecting module transmits the light with the first wavelength, and reflects the light with the second wavelength. By this means, it is possible to adopt a configuration such that one portion of light traveling from the resonator toward the light emitting element is reflected, and another one portion is transmitted.

Also, it is preferable that the light emitting element includes a substrate, a mirror layer formed on the substrate, and an active layer laminated on a surface of the mirror layer, wherein the active layer is connected to the wiring module. By this means, it is possible to emit light with a high efficiency.

Also, it is preferable that the resonator is disposed in a position of a beam waist of the light emitted from the light emitting modules. By this means, it is possible to resonate light efficiently between the light emitting modules and the resonator. The higher an output of the light emitting element becomes, the shorter a distance from the light emitting element to the beam waist becomes, due to a thermal lens effect of the light emitting element. According to this aspect of the invention, by disposing the transmitting-reflecting module in a position as near as possible to the light emitting element, enabling a disposition of the resonator in a position near the light emitting element, it is possible to emit light with a high efficiency.

Furthermore, an image display apparatus according to an aspect of the invention includes the heretofore described light source apparatus, wherein an image is displayed using light emitted from the light source apparatus. By using the heretofore described light source apparatus, it is possible to emit light with a high efficiency, with a simple and compact configuration. By this means, it is possible to obtain an image display apparatus which can display a bright image, with a simple and compact configuration.

Furthermore, a monitor apparatus according to an aspect of the invention includes the heretofore described light source apparatus, and an imaging module which images a subject illuminated by light emitted from the light source apparatus. By using the heretofore described light source apparatus, it is possible to emit light with a high efficiency, with a simple and compact configuration. By this means, it is possible to obtain a monitor apparatus which can monitor a bright image, with a simple and compact configuration.

### BRIEF DESCRIPTION OF THE DRAWINGS

The invention will be described with reference to the accompanying drawings, wherein like numbers reference like elements.

FIG. 1 shows a frontal outline configuration of a light source apparatus according to an embodiment 1 of the invention.

FIG. 2 shows a perspective outline configuration of a semiconductor element.

FIG. 3 schematically represents a sectional configuration of the semiconductor element.

FIG. 4 illustrates a disposition of a transmissive-reflective mirror.

FIG. 5 illustrates a disposition of a reflective mirror.

FIG. 6 shows a perspective outline configuration of a support column and a base.

FIG. 7 shows a lateral outline configuration of the light source apparatus.

FIG. 8 illustrates a disposition of the semiconductor element, the transmissive-reflective mirror, and the like.

FIG. 9 shows a perspective outline configuration of a support column according to a modification example of the embodiment 1, and the base.

FIG. 10 shows a sectional configuration of the support column shown in FIG. 9.

FIG. 11 shows a frontal outline configuration of a light source apparatus according to a modification example of the embodiment 1.

FIG. 12 shows an outline configuration of a projector according to an embodiment 2 of the invention.

FIG. 13 shows an outline configuration of a monitor apparatus according to an embodiment 3 of the invention.

### DESCRIPTION OF EXEMPLARY EMBODIMENTS

Hereafter, a detailed description will be given of embodiments of the invention, referring to the drawings.

### Embodiment 1

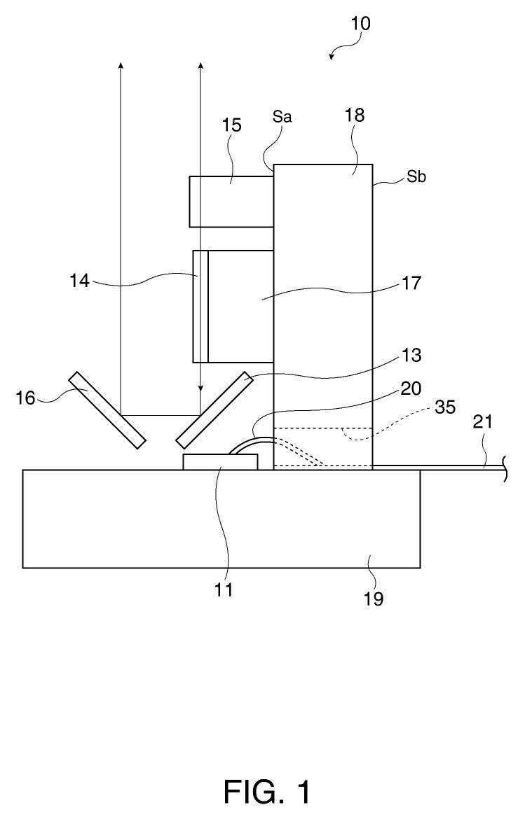

FIG. 1 shows a frontal outline configuration of a light source apparatus 10 according to an embodiment 1 of the invention. An arrow shown in the figure is taken to be a main beam of a light flux. The light source apparatus 10 is a laser light source which supplies a laser light. A semiconductor element 11 functions as a light emitting element which emits a fundamental wave light with a first wavelength. The fundamental wave light is, for example, an infrared light. The first wavelength is, for example, 1064 nm. The semiconductor element 11 is mounted on a base 19.

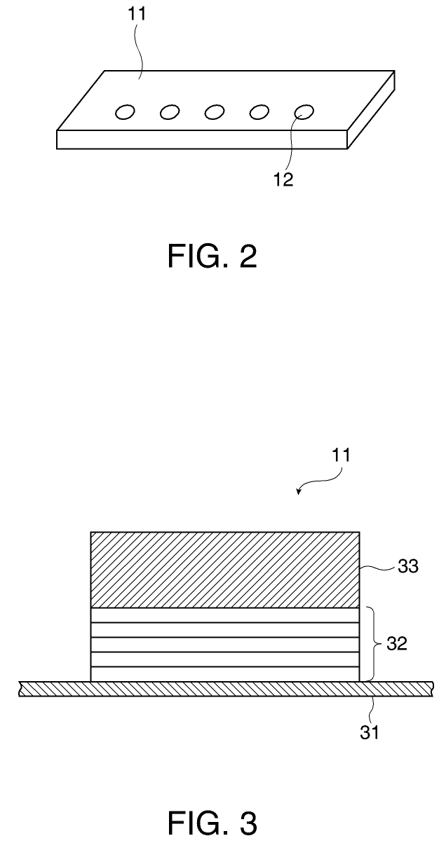

FIG. 2 shows a perspective outline configuration of the semiconductor element 11. The semiconductor element 11 is a surface light emitting type of semiconductor element. The semiconductor element 11 has five light emitting modules 12, which emit the fundamental wave light. The five light emitting modules 12 are disposed aligned in one row. In FIG. 1, the semiconductor element 11 is disposed in such a way that the five light emitting modules 12 are aligned in a direction perpendicular to a plane of the drawing.

FIG. 3 schematically represents a sectional configuration of the semiconductor element 11. A substrate 31 is formed of, for example, a semiconductor wafer. A mirror layer 32 is formed on the substrate 31. The mirror layer 32 is configured of a laminate of a derivative with a high refractive index and a derivative with a low refractive index, formed by, for example, a CVD (Chemical Vapor Deposition). A thickness of each layer configuring the mirror layer 32, a material of each layer, and a number of layers, being optimized for the first wavelength, are set to conditions whereby reflected beams interfere and reinforce each other. An active layer 33 is provided laminated on a surface of the mirror layer 32. The active layer 33 is connected to connecting wires 20, to be described hereafter. On a predetermined amount of current being supplied via the connecting wires 20 and a flexible substrate 21, the active layer 33 emits the fundamental wave light. The semiconductor element 11 emits the fundamental wave light, from an emission surface of the active layer 33, in a direction approximately perpendicular to the mirror layer 32 and the substrate 31.

Returning to FIG. 1, a transmissive-reflective mirror (an optical isolation module) 13 and an SHG element 14 are provided in an optical path between the semiconductor element 11 and a resonator (an external resonator) 15 disposed outside the semiconductor element 11. The transmissive-reflective mirror 13, being a broadband reflective mirror which transmits light with the first wavelength, and reflects light with a second wavelength, separates the light with the first wavelength and the light with the second wavelength. The transmissive-reflective mirror 13 functions as a transmitting-reflecting module, which reflects one portion of light traveling toward the semiconductor element 11 from the external resonator 15, and transmits another one portion. The transmissive-reflective mirror 13 is configured by coating a wavelength selection film, for example, a dielectric multilayer film, on a transparent member, which is a parallel plate.

The SHG element 14 is a wavelength conversion element which, by converting the wavelength of the fundamental wave light with the first wavelength, emitted from the semiconductor element 11, emits a harmonic light with the second wavelength. The harmonic light is, for example, a visible light. The second wavelength, being a wavelength which is one half of the first wavelength, is, for example, 532 nm. The SHG element 14 forms a rectangular parallelepiped shape. As the SHG element 14, it is possible to use, for example, a nonlinear optical crystal. As the nonlinear optical crystal, for example, a lithium niobate (LiNbO₃) polarization inversion crystal (Periodically Poled Lithium Niobate; PPLN) is used. The SHG element 14 has a polarization inversion structure with a pitch corresponding to the first wavelength of the fundamental wave light. By using the SHG element 14, it is possible, using a widely available general-purpose light emitting element, to supply a laser light with a desired wavelength and a sufficient light quantity.

The external resonator 15 resonates the light emitted from the light emitting modules 12. As the external resonator 15, a volume hologram, which selectively reflects the light with the first wavelength by diffraction, is used. The volume hologram functions as a narrowband reflective mirror which has a reflection characteristic such that, in an infrared region, a half bandwidth is a few nm or less centered on the first wavelength. Also, the volume hologram, in a visible region, transmits light in a wide wavelength range, including the second wavelength.

The volume hologram is, for example, a VHG (Volume Holographic Grating). The VHG can be formed using a photorefractive crystal of LiNbO₃, BGO or the like, a polymer, or the like. An interference pattern, caused by incident light falling incident from two directions, is recorded in the volume hologram. The interference pattern is recorded as a periodic structure in which a high refractive index portion and a low refractive index portion are periodically aligned. The volume hologram selectively reflects by diffraction only light in which the interference pattern and the Bragg condition conform. The mirror layer 32 (refer to FIG. 3) of the semiconductor element 11, and the external resonator 15, configure a resonating structure which resonates the light with the first wavelength.

A reflective mirror 16 is provided in a position which is on a side opposite to a side of the transmissive-reflective mirror 13 on which a support column 18 is provided, and on which light reflected by a second surface S2 of the transmissive-reflective mirror 13 falls incident. The reflective mirror 16 reflects the light from the transmissive-reflective mirror 13. The reflective mirror 16 is configured by coating a reflective film, for example, a dielectric multilayer film, on a transparent member, which is of a parallel plate form. It being sufficient that the reflective mirror 16 is configured using a highly reflective member, it is also acceptable that it is configured by, for example, coating a metal film thereon.

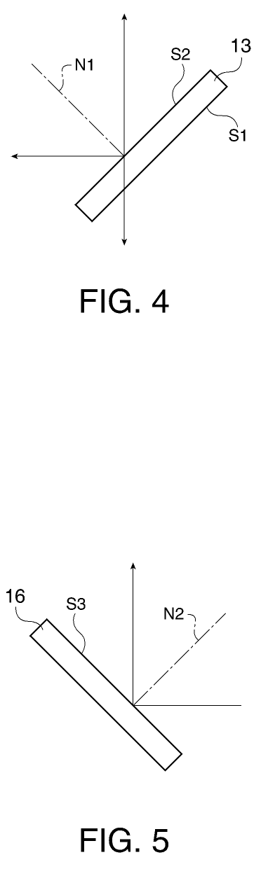

FIG. 4 illustrates a disposition of the transmissive-reflective mirror 13. The transmissive-reflective mirror 13 has a first surface S1, directed toward a side on which the semiconductor element 11 is provided, and the second surface S2, directed toward a side on which the SHG element 14 and external resonator 15 are provided. The unshown wavelength selection film is provided on the second surface S2 of the transmissive-reflective mirror 13. A normal N1 of the second surface S2 is tilted at approximately 45 degrees in a specific direction relative to the main light beam of the light flux traveling between the transmissive-reflective mirror 13 and the external resonator 15, that is, in a direction relative to the transmissive-reflective mirror 13 opposite to a direction of the support column 18.

FIG. 5 illustrates a disposition of the reflective mirror 16. The reflective mirror 16 is disposed directing a reflection surface S3 toward a side on which the transmissive-reflective mirror 13 is provided. The unshown reflective film is provided on the reflection surface S3 of the reflective mirror 16. A normal N2 of the reflection surface S3 is tilted at approximately 45 degrees in the direction of the support column 18 from the reflective mirror 16 relative to the main light beam of the light flux from the transmissive-reflective mirror 13. The second surface S2 of the transmissive-reflective mirror 13, and the reflection surface S3 of the reflective mirror 16, are approximately perpendicular to each other. It is also acceptable to configure the transmissive-reflective mirror 13 and the reflective mirror 16 as a unit by coating a dielectric multilayer film on a common transparent member.

Returning to FIG. 1, the base 19 is configured using a metal member, for example, a copper member. The base 19 forms an approximate rectangular parallelepiped shape. The support column 18 is provided on the base 19. An SHG element mount 17 and the external resonator 15 are attached to a first side surface Sa on the semiconductor element 11 side of the support column 18. The SHG element 14 is attached to the SHG element mount 17. The support column 18 functions as a supporting module which supports the external resonator 15 and the SHG element 14 on the base 19. The support column 18 is configured using a metal member, for example, a copper member. It is also acceptable to attach the external resonator 15 to the support column 18 via a mount. Also, it is also acceptable to attach the SHG element 14 directly to the support column 18, without using the SHG mount 17.

A flexible substrate 21 is mounted on the base 19. The flexible substrate 21 functions as a current supply module which supplies a current to each light emitting module 12 of the semiconductor element 11. The connecting wires 20 function as a wiring module which connects the flexible substrate 21 and the semiconductor element 11.

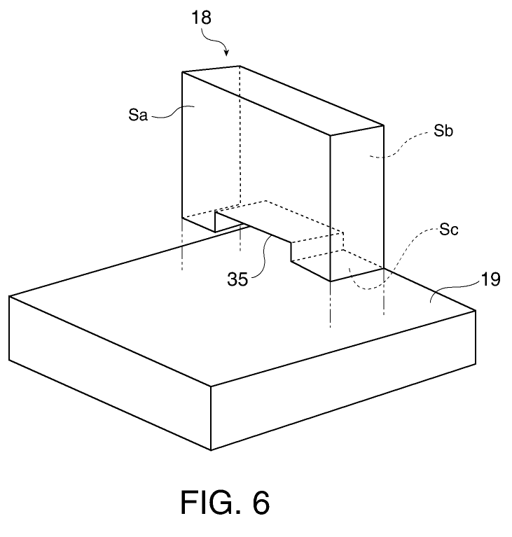

FIG. 6 shows a perspective outline configuration of the support column 18 and base 19. The support column 18 is an approximately rectangular parallelepiped shaped member in which a stepped portion 35 is provided. The stepped portion 35 is formed in such a way as to be depressed in a bottom surface Sc on a base 19 side of the support column 18, toward a side opposite to the base 19. The stepped portion 35 is provided in a vicinity of the connecting wires 20 (refer to FIG. 1). The stepped portion 35 is formed from the first side surface Sa to a second side surface Sb. By forming the stepped portion 35 in the support column 18, the support column 18 and the base 19 configure a void.

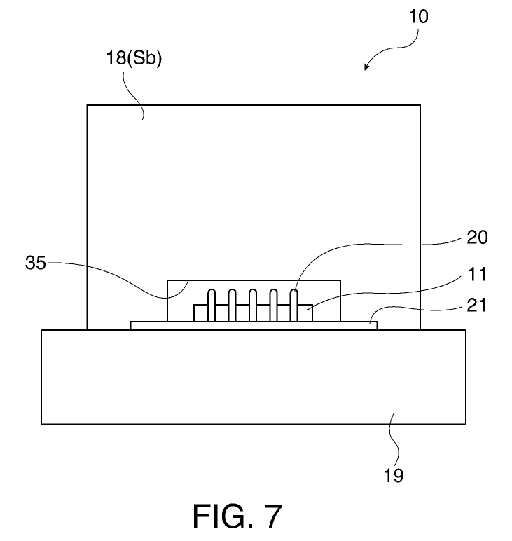

FIG. 7 shows a lateral outline configuration of the light source apparatus 10 seen from a second side surface Sb side of the support column 18. By providing the support column 18 on the base 19, the void is formed between the stepped portion 35 of the support column 18, and the base 19. This void is formed in such a way as to penetrate from the first side surface Sa of the support column 18, on the semiconductor element 11 side, to the second side surface Sb on a side opposite to the semiconductor element 11 side. A portion of the flexible substrate 21 connected to the connecting wires 20 is disposed inside this void. Five connecting wires 20 are provided, corresponding to the light emitting modules 12. The connecting wires 20 are not limited to the case of being of the same number as the light emitting modules 12. For example, it is also acceptable to provide less connecting wires 20 than light emitting modules 12, pairing a plurality of light emitting modules 12 with one connecting wire 20. The support column 18 and base 19 are not limited to the case of configuring the void only by forming the stepped portion 35 in the support column 18. It is also acceptable that the support column 18 and base 19, for example, make a void by combining the stepped portion 35 formed in the support column 18, and a recessed portion formed in the base 19, and it is also acceptable that a void is configured by only forming a recessed portion in the base 19.

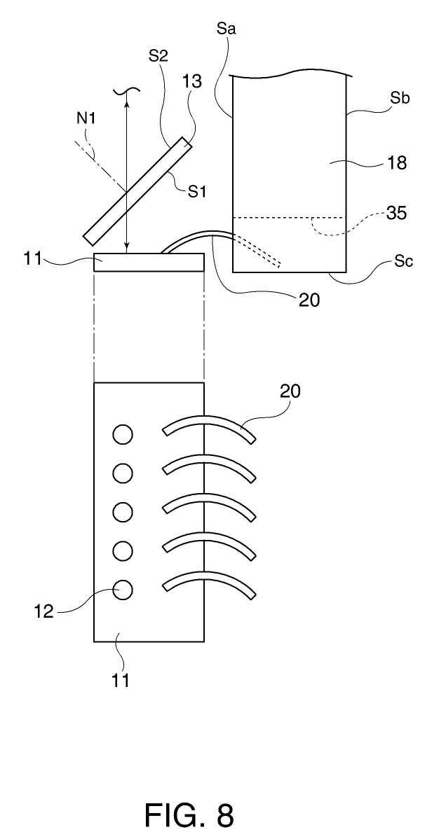

FIG. 8 illustrates a disposition of the semiconductor element 11, the transmissive-reflective mirror 13, and the connecting wires 20. An upper section of the figure shows a frontal configuration of one portion of the support column 18, the semiconductor element 11, the transmissive-reflective mirror 13, and the connecting wires 20. Middle and lower sections of the figure show a top view configuration of, among the configurations shown in the upper section, the semiconductor element 11 and the connecting wires 20. The five connecting wires 20 are provided aligned in a direction the same as the direction in which the light emitting modules 12 are aligned.

All of the five connecting wires 20 are provided, relative to the light emitting modules 12, on a side on which the support column 18 is provided. The normal N1 of the second surface S2 is tilted in a specific direction, opposite to the direction of the support column 18 as seen from the transmissive-reflective mirror 13, relative to the main light beam of the light flux traveling between the transmissive-reflective mirror 13 and the external resonator 15. The five connecting wires 20 are provided on a side of the light emitting modules 12 opposite to the side of this specific direction.

The transmissive-reflective mirror 13, in order to reflect the harmonic light from the SHG element 14 toward the reflective mirror 16, is tilted in such a way that a distance from the semiconductor element 11 of an extremity on the reflective mirror 16 side is shorter than that of an extremity on the support column 18 side. There is a need to secure a space in the light source apparatus 10, on the emission side of the semiconductor element 11, in order to dispose the connecting wires 20. Provisionally supposing that the connecting wires 20 are provided on the side of the light emitting modules 12 opposite to the support column 18 side, as it necessary to secure a space to provide the connecting wires 20 between the semiconductor element 11 and the reflective mirror 16, it becomes difficult to dispose the reflective mirror 16 in a position near the semiconductor element 11. With the light source apparatus 10 of the embodiment, by providing the connecting wires 20 on the support column 18 side of the light emitting modules 12, it is possible to adopt a configuration such that the transmissive-reflective mirror 13 is disposed in a position as near as possible to the semiconductor element 11, while preventing interference between the connecting wires 20 and the transmissive-reflective mirror 13.

Next, using FIG. 1, a description will be given of a process by which the laser light is emitted by the light source apparatus 10. The fundamental wave light emitted from the light emitting modules 12 (refer to FIG. 2) falls incident on the transmissive-reflective mirror 13. The fundamental wave light falling incident on the transmissive-reflective mirror 13, after passing through the transmissive-reflective mirror 13, falls incident on the SHG element 14. The harmonic light generated by causing the fundamental wave light from the transmissive-reflective mirror 13 to fall incident on the SHG element 14 passes through the external resonator 15. The harmonic light which has passed through the external resonator 15 is emitted to an exterior of the light source apparatus 10.

After passing through the SHG element 14, the fundamental wave light falling incident on the external resonator 15 is reflected by the external resonator 15. After being reflected by the external resonator 15, the fundamental wave light which has passed through the SHG element 14, after passing through the transmissive-reflective mirror 13, falls incident on the light emitting modules 12 of the semiconductor element 11. The fundamental wave light falling incident on the light emitting modules 12 is reflected by the mirror layer 32 (refer to FIG. 3), and travels in the direction of the SHG element 14. By resonating the fundamental wave light between the mirror layer 32 and the external resonator 15, the active layer 33 (refer to FIG. 3) amplifies the fundamental wave light. Also, the fundamental wave light reflected by the mirror layer 32 and the external resonator 15 is amplified by resonating with a fundamental wave light newly emitted by the active layer 33.

An optical path of the harmonic light generated by causing the fundamental wave light from the external resonator 15 to fall incident on the SHG element 14 is bent by approximately 90 degrees by reflecting with the transmissive-reflective mirror 13. The harmonic light reflected by the transmissive-reflective mirror 13 falls incident on the reflective mirror 16. The optical path of the harmonic light falling incident on the reflective mirror 16 is bent by approximately 90 degrees by a reflection with the reflective mirror 16. Due to the bending of the optical path with the transmissive-reflective mirror 13 and the reflective mirror 16, the optical path of the harmonic light which has traveled from the SHG element 14 to the transmissive-reflective mirror 13 is converted by approximately 180 degrees, and travels in the same direction as the harmonic light which has passed through the external resonator 15. With the light source apparatus 10, adopting a simple and compact configuration including a small number of optical elements, it is possible to reduce a loss of light.

A temperature of the active layer 33 of the semiconductor element 11 (refer to FIG. 3) rises locally due to the current supply, and to the irradiation with the fundamental wave light. A thermal lens effect is a phenomenon whereby, due to the localized temperature rise, a refractive index distribution occurs in the active layer 33. The semiconductor element 11, due to the thermal lens effect, emits a slightly convergent fundamental wave light. It is desirable that the external resonator 15 is disposed in a position of a beam waist of the light emitted from the light emitting modules 12. By disposing the external resonator 15 in the position of the beam waist, it becoming possible to efficiently return the light reflected by the external resonator 15 to the light emitting modules 12, it is possible to efficiently resonate the light between the light emitting modules 12 and the external resonator 15.

Herein, as the temperature of the active layer 33 becomes high in the event that the output of the semiconductor element 11 is high, the thermal lens effect of the semiconductor element 11 becomes significant. On the influence of the thermal lens effect increasing, a distance from the semiconductor element 11 to the beam waist decreases. In the event that the distance from the semiconductor element 11 to the beam waist decreases, a need occurs in the light source apparatus 10 to decrease distances between each of the elements disposed in the optical path from the semiconductor element 11 to the external resonator 15. As it is possible to dispose the transmissive-reflective mirror 13 in a position as near as possible to the semiconductor element 11 in the light source apparatus 10 of the embodiment, the light source apparatus 10 is suited to a case in which it is necessary to decrease the distance from the semiconductor element 11 to the external resonator 15. In particular, it being possible to dispose the external resonator 15 in the position of the beam waist when using a high output semiconductor element 11, it is possible to emit the light with a high efficiency. By means of the above, an advantageous effect is achieved whereby light can be emitted with a high efficiency, with a simple and compact configuration.

The case of using a volume hologram as the external resonator 15 is not limiting. It is also acceptable to use a broadband reflective mirror as the external resonator 15. It is also acceptable to provide optical elements such as a polarization selection filter or a wavelength selection filter, as necessary, in the optical path between the semiconductor element 11 and the external resonator 15. The semiconductor element 11 is not limited to the configuration wherein it includes the five light emitting modules 12 aligned in one row. It is sufficient that the semiconductor element 11 is of a configuration wherein it includes a plurality of light emitting modules 12. It is also acceptable to arrange in such a way that, in the semiconductor element 11, a plurality of light emitting modules 12 are disposed in an array in a planar direction. The light source apparatus 10 is not limited to the configuration wherein all of the connecting wires 20 are provided on the side of the light emitting modules 12 opposite to the side of the specific direction. It is sufficient that the light source apparatus 10 is of a configuration wherein at least one of the connecting wires 20 is provided on the side of the light emitting modules 12 opposite to the side of the specific direction.

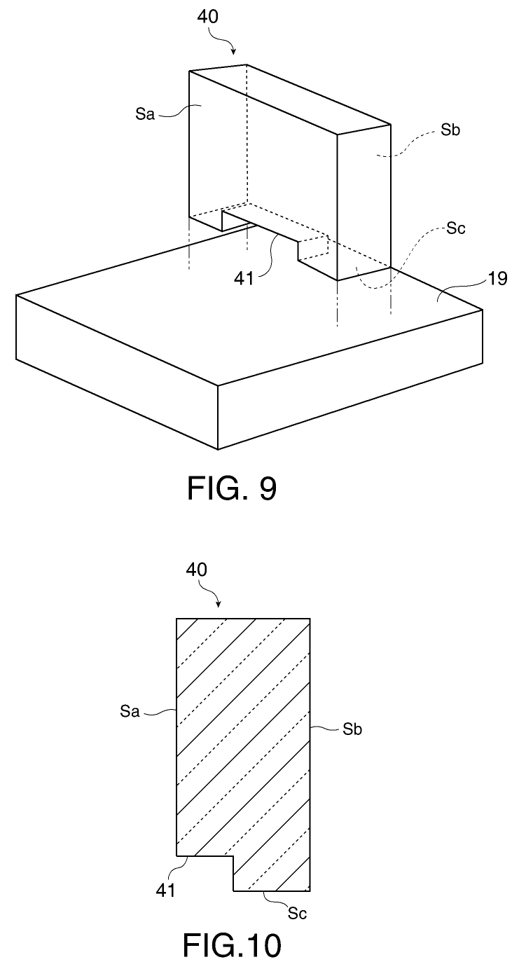

FIG. 9 shows a perspective outline configuration of a support column 40 according to a modification example of the embodiment, and the base 19. FIG. 10 shows a sectional configuration of the support column 40 shown in FIG. 9. The support column 40 according to the modification example can be applied to the heretofore described light source apparatus 10. The support column 40 functions as a supporting module which supports the external resonator 15 and the SHG element 14 on the base 19. The section shown in FIG. 10 is a surface which is approximately perpendicular to a first side surface Sa, a second side surface Sb, and a bottom surface Sc of the support column 40.

The support column 40 is an approximately rectangular parallelepiped shaped member in which a stepped portion 41 is provided. The stepped portion 41 is formed in a vicinity of the connecting wires 20 (refer to FIG. 1). As opposed to the stepped portion 35 formed in the support column 18 shown in FIG. 6, which is formed from the first side surface Sa to the second side surface Sb, the stepped portion 41 in the modification example is formed from the first side surface Sa to a position short of reaching the second side surface Sb. By forming the stepped portion 41 in the support column 40, the support column 40 and the base 19 configure a void.

By disposing the support column 40 on the base 19, a recessed portion is formed between the stepped portion 41 of the support column 40 and the base 19. This recessed portion is formed in such a way as to cause a depression in the first side surface Sa of the support column 40, on which the external resonator 15 and SHG element mount 17 are provided. The portion of the flexible substrate 21 (refer to FIG. 1) connected to the connecting wires 20 is disposed inside this recessed portion. In this modification example too, by securing a space in which to dispose the connecting wires 20, it is possible to prevent interference between the connecting wires 20 and the support column 40. The support column 40 and base 19 are not limited to the case of configuring the void only by forming the stepped portion 41 in the support column 40. It is also acceptable that the support column 40 and base 19, for example, make a void by combining the stepped portion 41 formed in the support column 40, and a recessed portion formed in the base 19, and it is also acceptable that a void is configured by only forming a recessed portion in the base 19. The support columns 18 and 40 are not limited to the case of being of the form described in the embodiment. It being sufficient that it is possible to secure a space in which to dispose the connecting wires 20, it is also acceptable to appropriately modify the support columns 18 and 40.

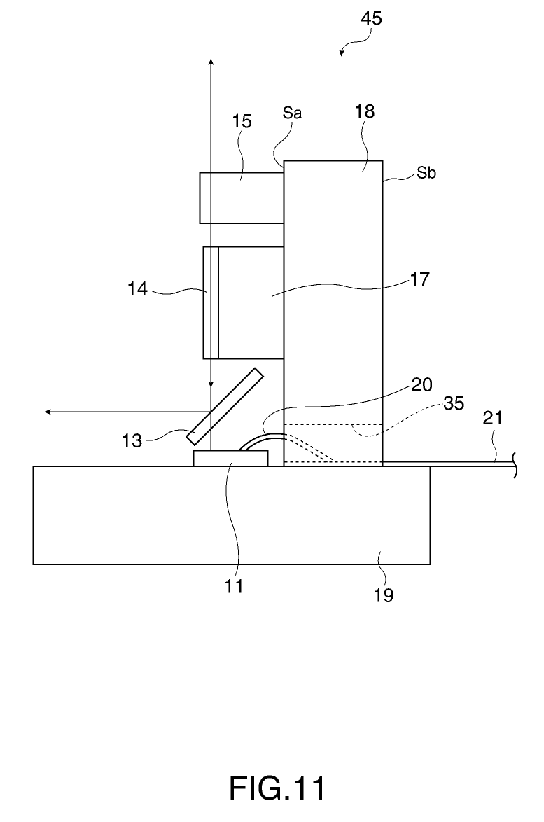

FIG. 11 shows a frontal outline configuration of a light source apparatus 45 according to a modification example of the embodiment. The light source apparatus 45 according to the modification example is one in which the reflective mirror 16 is omitted from the configuration of the heretofore described light source apparatus 10 (refer to FIG. 1). The harmonic light reflected by the transmissive-reflective mirror 13 is emitted as it is from the light source apparatus 45. With the light source apparatus 45, the harmonic light which passes through the external resonator 15, and the harmonic light reflected by the transmissive-reflective mirror 13, are emitted in a condition in which their directions of travel are at approximately 90 degrees to each other. In the case of this modification example too, it is possible to emit light with a high efficiency, using a simple and compact configuration. It is also acceptable to arrange in such a way that an image display apparatus or monitor apparatus using the light source apparatus 45 according to the modification example, by appropriately applying optical elements, converts the direction of travel of the laser light emitted from the light source apparatus 45. It is also acceptable that each of the light source apparatus according to the embodiment is of a configuration which does not have a wavelength conversion element. Even in the case of not having a wavelength conversion element, the light source apparatus, enabling a disposition of a resonator in a position near the light emitting element, can achieve an advantageous effect of being able to emit light with a high efficiency, in the same way as in the case of the embodiment, which has a wavelength conversion element.

### Embodiment 2

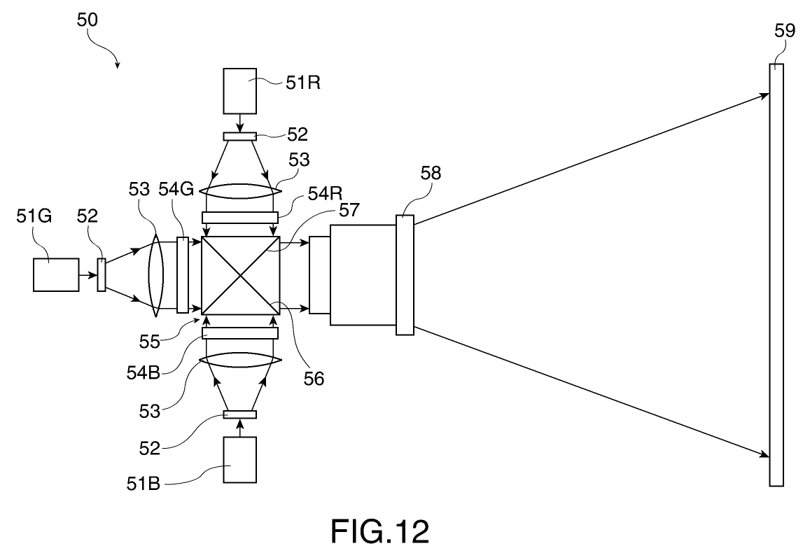

FIG. 12 shows an outline configuration of a projector 50 according to an embodiment 2 of the invention. The projector 50 is a front projection type of projector which projects light onto a screen 59, wherein an image is watched by observing the light reflected on the screen 59. The projector 50 has a red (R) light light source apparatus 51R, a green (G) light light source apparatus 51G, and a blue (B) light light source apparatus 51B. Each light color light source apparatus 51R, 51G and 51B has the same configuration as the light source apparatus 10 (refer to FIG. 1) of the heretofore described embodiment 1. The projector 50 is an image display apparatus which displays an image using light from each light color light source apparatus 51R, 51G and 51B.

The R light light source apparatus 51R is a light source apparatus which emits R light. A diffusion element 52 carries out a shaping and enlargement of an illumination area, and an equalization of a light quantity distribution in the illumination area. As the diffusion element 52, for example, a computer generated hologram (CGH), which is a diffractive optical element, is used. A field lens 53 parallelizes the light from the R light light source apparatus 51R, and causes it to fall incident on an R light spatial light modulation device 54R. The R light light source apparatus 51R, the diffusion element 52, and the field lens 53 configure an illumination apparatus which illuminates the R light spatial light modulation device 54R. The R light spatial light modulation device 54R, being a spatial light modulation device which modulates the R light from the illumination apparatus in accordance with an image signal, is a transmissive type of liquid crystal display device. The R light modulated by the R light spatial light modulation device 54R falls incident on a cross dichroic prism 55, which is a color synthesizing optical system.

The G light light source apparatus 51G is a light source apparatus which emits G light. Light which has passed through the diffusion element 52 and field lens 53 falls incident on a G light spatial light modulation device 54G. The G light light source apparatus 51G, the diffusion element 52, and the field lens 53 configure an illumination apparatus which illuminates the G light spatial light modulation device 54G. The G light spatial light modulation device 54G, being a spatial light modulation device which modulates the G light from the illumination apparatus in accordance with an image signal, is a transmissive type of liquid crystal display device. The G light modulated by the G light spatial light modulation device 54G falls incident on a surface of the cross dichroic prism 55 differing from a surface on which the R light falls incident.

The B light light source apparatus 51B is a light source apparatus which emits B light. Light which has passed through the diffusion element 52 and field lens 53 falls incident on a B light spatial light modulation device 54B. The B light light source apparatus 51B, the diffusion element 52, and the field lens 53 configure an illumination apparatus which illuminates the B light spatial light modulation device 54B. The B light spatial light modulation device 54B, being a spatial light modulation device which modulates the B light from the illumination apparatus in accordance with an image signal, is a transmissive type of liquid crystal display device. The B light modulated by the B light spatial light modulation device 54B falls incident on a surface of the cross dichroic prism 55 differing from the surface on which the R light falls incident, and the surface on which the G light falls incident. As the transmissive type of liquid crystal display device, for example, a high temperature polysilicon (HTPS) TFT liquid crystal panel is used.

The cross dichroic prism 55 has two dichroic films 56 and 57, disposed approximately perpendicular to each other. The first dichroic film 56 reflects the R light, and transmits the G light and the B light. The second dichroic film 57 reflects the B light, and transmits the R light and the G light. The cross dichroic prism 55 synthesizes the R light, the G light and the B light, each falling incident from a different direction, and emits them in a direction of a projection lens 58. The projection lens 58 projects the light synthesized by the cross dichroic prism 55 toward the screen 59. By using each light color light source apparatus 51R, 51G and 51B, which have the same configuration as the heretofore described light source apparatus 10, the projector 50 can display a bright image with a simple and compact configuration.

The projector is not limited to the case of using a transmissive type of liquid crystal display device as a spatial light modulation device. It is also acceptable to use a reflective type of liquid crystal display device (Liquid Crystal On Silicon; LCOS), a DMD (Digital Micromirror Device) a GLV (Grating Light Valve), or the like, as the spatial light modulation device. The projector is not limited to the configuration which includes a spatial light modulation device for each color of light. It is also acceptable to adopt a configuration such that the projector modulates two, or three or more, colors of light with one spatial light modulation device. The projector is not limited to the case of using a spatial light modulation device. It is also acceptable that the projector is a laser scanner type of projector which causes the laser light from the light source apparatus to be scanned with a scanning module, such as a galvanic mirror, and displays an image on an irradiated surface. It is also acceptable that the projector is a slide projector, which uses a slide in which is held image information. It is also acceptable that the projector is a so-called rear projector, wherein light is supplied to one surface of a screen, and an image is watched by observing a light emitted from the other surface of the screen.

### Embodiment 3

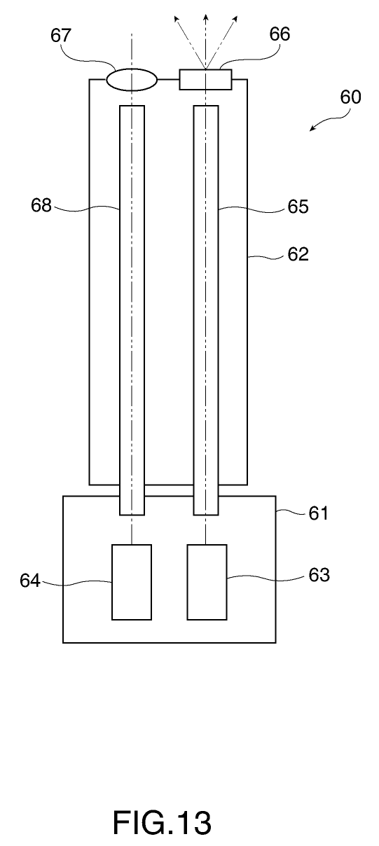

FIG. 13 shows an outline configuration of a monitor apparatus 60 according to an embodiment 3 of the invention. The monitor apparatus 60 has an apparatus main body 61 and a light transmission section 62. The apparatus main body 61 has a light source apparatus 63. The light source apparatus 63 has the same configuration as that of the light source apparatus 10 (refer to FIG. 1) of the heretofore described embodiment 1. The light transmission section 62 has two light guides 65 and 68. A diffusion plate 66 and an imaging lens 67 are provided at an extremity of a subject (not shown) side of the light transmission section 62. The first light guide 65 transmits light from the light source apparatus 63 to the subject. The diffusion plate 66 is provided on an emission side of the first light guide 65. The light which has propagated inside the first light guide 65 diffuses on the subject side by passing through the diffusion plate 66.

The second light guide 68 transmits light from the subject to a camera 64. The imaging lens 67 is provided on an incident side of the second light guide 68. The imaging lens 67 causes the light from the subject to collect in an incidence plane of the second light guide 68. The light from the subject, after being caused to enter the second light guide 68 by the imaging lens 67, propagates inside the second light guide 68, and enters the camera 64.

As the first light guide 65 and second light guide 68, for example, one in which a large number of optical fibers are bunched together is used. By using the light fibers, it is possible to transmit the light to a distance. The camera 64 is provided inside the apparatus main body 61. The camera 64 is an imaging module which images the subject illuminated by the light from the light source apparatus 63. By causing the light emitted from the second light guide 68 to enter the camera 64, the subject is imaged by the camera 64. By using the light source apparatus 63, which has the same configuration as the light source apparatus 10 of the heretofore described embodiment 1, the monitor apparatus 60 can monitor a bright image with a simple and compact configuration.

It is also acceptable to apply the light source apparatus according to the invention to a liquid crystal display, which is an image display apparatus. In this case too, it is possible to display a bright image. The light source apparatus according to the invention is not limited to the case of being applied to a monitor apparatus or image display apparatus. It is also acceptable to use the light source apparatus according to the invention in, for example, an optical system such as an exposure apparatus for an exposure using a laser light, or a laser processing apparatus.

As heretofore described, the light source apparatus according to the invention is suited to a case of being used in a monitor apparatus or an image display apparatus.

The entire disclosure of Japanese Patent Application No. 2008-34112, filed Feb. 15, 2008 is expressly incorporated by reference herein.

What is claimed is:

1. A light source apparatus comprising:
a light emitting element including a plurality of light emitting modules which emit light;
a resonator which resonates the light emitted from the light emitting modules;
a transmitting-reflecting module which, being provided in an optical path between the light emitting element and the resonator, reflects one portion of light traveling from the resonator toward the light emitting element, and transmits another one portion;
a current supply module which supplies a current to the light emitting modules; and
at least one wiring module which connects the current supply module and the light emitting element, wherein
a normal of a surface of the transmitting-reflecting module on which the light from the resonator falls incident is tilted in a specific direction relative to a main beam of a light flux which travels between the transmitting-reflecting module and the resonator, and
at least one of the wiring modules is provided on a side of the light emitting modules opposite to a side of the specific direction.

2. The light source apparatus according to claim 1, comprising:
a base on which the light emitting element is disposed; and
a supporting module which supports at least the resonator on the base, wherein
at least one of the wiring modules is provided on a side of the light emitting modules on which the supporting module is provided.

3. The light source apparatus according to claim 2, wherein
the base and the supporting member configure a void, in a vicinity of the wiring module, penetrating from the light emitting element side to a side opposite to the light emitting element.

4. The light source apparatus according to claim 2, wherein
the base and the supporting member configure a recessed portion, in the vicinity of the wiring module, which causes a depression in a surface on which the resonator is provided.

5. The light source apparatus according to claim 1, comprising:
a wavelength conversion element which, by converting a wavelength of light with a first wavelength emitted from the light emitting modules, emits light with a second wavelength, which is a wavelength differing from the first wavelength, wherein
the transmitting-reflecting module transmits the light with the first wavelength, and reflects the light with the second wavelength.

6. The light source apparatus according to claim 5, comprising:
a reflecting module which, being provided in a position on which the light reflected by the transmitting-reflecting module falls incident, reflects the light from the transmitting-reflecting module, wherein
a normal of a surface of the reflecting module on which the light from the transmitting-reflecting module falls incident is tilted in a specific direction relative to a main beam of a light flux from the transmitting-reflecting module.

7. The light source apparatus according to claim 1, wherein
the light emitting element includes:
a substrate;
a mirror layer formed on the substrate; and
an active layer laminated on a surface of the mirror layer, wherein
the active layer is connected to the wiring module.

8. The light source apparatus according to claim 7, wherein
the resonator is disposed in a position of a beam waist of the light emitted from the light emitting modules.

9. A light source apparatus comprising:
a light emitting element including a plurality of light emitting modules which emit light;
a resonator which resonates the light emitted from the light emitting modules;
a transmitting-reflecting module which, being provided in an optical path between the light emitting element and the resonator, reflects one portion of light traveling from the resonator toward the light emitting element, and transmits another one portion;
a current supply module which supplies a current to the light emitting modules; and
at least one wiring module which connects the current supply module and the light emitting element, wherein
a normal of a surface of the transmitting-reflecting module which reflects one portion of the light from the resonator is tilted in a specific direction relative to a main beam of a light flux which travels between the transmitting-reflecting module and the resonator, and
at least one of the wiring modules is provided on a side of the light emitting modules opposite to a side of the specific direction.

10. The light source apparatus according to claim 9, comprising:
a base on which the light emitting element is disposed; and
a supporting module which supports at least the resonator on the base, wherein
at least one of the wiring modules is provided on a side of the light emitting modules on which the supporting module is provided.

11. The light source apparatus according to claim 10, wherein
the base and the supporting member configure a void, in a vicinity of the wiring module, penetrating from the light emitting element side to a side opposite to the light emitting element.

12. The light source apparatus according to claim 10, wherein
the base and the supporting member configure a recessed portion, in the vicinity of the wiring module, which causes a depression in a surface on which the resonator is provided.

13. The light source apparatus according to claim 9, comprising:
a wavelength conversion element which, by converting a wavelength of light with a first wavelength emitted from the light emitting modules, emits light with a second wavelength, which is a wavelength differing from the first wavelength, wherein
the transmitting-reflecting module transmits the light with the first wavelength, and reflects the light with the second wavelength.

14. The light source apparatus according to claim 13, comprising:
a reflecting module which, being provided in a position on which the light reflected by the transmitting-reflecting module falls incident, reflects the light from the transmitting-reflecting module, wherein
a normal of a surface of the reflecting module on which the light from the transmitting-reflecting module falls incident is tilted in a specific direction relative to a main beam of a light flux from the transmitting-reflecting module.

15. An image display apparatus comprising the light source apparatus according to claim 1, wherein an image is displayed using light emitted from the light source apparatus.

16. A monitor apparatus comprising:
the light source apparatus according to claim 1; and
an imaging module which images a subject illuminated by light emitted from the light source apparatus.

17. An image display apparatus comprising the light source apparatus according to claim 9, wherein an image is displayed using light emitted from the light source apparatus.

18. A monitor apparatus comprising:
the light source apparatus according to claim 9; and
an imaging module which images a subject illuminated by light emitted from the light source apparatus.
